(19) United States
(12) Patent Application Publication
(10) Pub. No.: US 2016/0117737 A1
(43) Pub. Date: Apr. 28, 2016

(54) Preference Mapping for Automated Attribute-Selection in Campaign Design

(71) Applicant: Adobe Systems Incorporated, San Jose, CA (US)

(72) Inventors: Moumita Sinha, Kolkata (IN); Rishiraj Saha Roy, Kolkata (IN); Ritwik Sinha, Kolkata (IN)

(21) Appl. No.: 14/526,250

(22) Filed: Oct. 28, 2014

(51) Int. Cl. G06Q 30/02

(52) U.S. Cl. CPC G06Q 30/0276; G06Q 30/0245

(57) ABSTRACT

Techniques for preference mapping for automated attribute selection in campaign design are described. In one or more implementations, consumer preference data associated with a plurality of products including a client product is analyzed by one or more computing devices to determine user sentiments associated with attributes that correspond to respective products. In addition, scores are assigned to the attributes based on the user sentiments associated with the attributes. Then, a preference mapping is performed using the assigned scores to generate a displayable representation of a comparison between at least two of the plurality of products based on the consumer preference data and a relative proximity of each attribute to corresponding products with respect to associated user sentiment. Subsequently, the displayable representation is communicated such that the displayable representation is identifiable regarding which attributes of the client product to highlight in a marketing campaign.

### BACKGROUND

Generally, designing a campaign to market a new product can be challenging. For example, new products have many features, but not all of the features can be included in a targeted marketing campaign. If the marketing campaign focuses on features that do not appeal to potential customers, then the marketing campaign can result in poor market performance (e.g., low sales) and lost potential revenue.

### SUMMARY

Techniques for preference mapping for automated attribute selection in campaign design are described. In one or more implementations, consumer preference data associated with a plurality of products including a client product is analyzed by one or more computing devices to determine user sentiments associated with attributes that correspond to respective products. In addition, scores are assigned to the attributes based on the user sentiments associated with the attributes. Then, a preference mapping is performed using the assigned scores to generate a displayable representation of a comparison between at least two of the plurality of products based on the consumer preference data and a relative proximity of each attribute to corresponding products with respect to associated user sentiment. Subsequently, the displayable representation is communicated such that the displayable representation is identifiable regarding which attributes of the client product to highlight in a marketing campaign.

In an example implementation, a request is transmitted to a service provider to identify attributes of a client product to target in a marketing campaign for the client product based on consumer preference data. Subsequently, a displayable representation is received that illustrates a comparison of the client product to one or more competitor products based on the consumer preference data and a relative proximity of attributes to corresponding products with respect to associated user sentiment identified in the consumer preference data. In addition, the displayable representation is used to identify the attributes of the client product to target in the marketing campaign for the client product.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques for preference mapping for automated attribute selection in campaign design.

FIG. 2 is an illustration of an example implementation that is operable to employ techniques for preference mapping for automated attribute selection in campaign design.

FIG. 3 is an illustration of an example implementation in which average sentiment scores of various attributes for different models of a product are charted.

FIG. 4 is an illustration of an example implementation of a preference map that shows weighted scores of products and eigenvector attributes.

FIG. 5 is a flow diagram depicting a procedure in an example implementation in which techniques for preference mapping for automated attribute selection in campaign design are employed.

FIG. 6 is a flow diagram depicting a procedure in an example implementation in which techniques for preference mapping for automated attribute selection in campaign design are employed.

FIG. 7 illustrates various components of an example device that can be implemented as any type of computing device as described herein to implement the techniques described herein.

### DETAILED DESCRIPTION

Overview

Conventional techniques used for selecting which attributes to target in a marketing campaign for a new product can result in poor performance of the marketing campaign and low sales of the new product. For example, a digital camera can have multiple defining aspects such as power of zoom, size of display, image size in megapixels, and so on. A release of a new camera model can be followed by a marketing campaign to potential customers that highlights certain aspects or attributes of the new camera model. This attribute selection process can be critical to the success of the marketing campaign. For instance, a marketing campaign that focuses on features that do not appeal to customers can result in poor performance of the marketing campaign and low sales of the product since the customers may not be incentivized or persuaded to purchase the product. In addition, conventional recommendation algorithms that rely heavily on large amounts of existing customer preference data available with an advertiser can suffer from a “cold start problem” of having an insufficient amount of data required to provide an accurate recommendation. These conventional techniques can also suffer from data sparsity and model scalability, which can lead to poor recommendations.

Techniques involving preference mapping for automated attribute selection in campaign design are described. In the following discussion, a variety of different implementations are described that involve preference mapping for automated attribute selection in campaign design. In one example, consumer preference data is analyzed to identify user sentiments associated with various attributes of a product as well as attributes of competitor products. For example, consumers can provide consumer preference data, such as user feedback or product reviews of a product (e.g., a camera). This consumer preference data is collected and reviewed to extract user sentiments associated with attributes of the product, such as zoom quality, start time, shutter speed, and so on. For example, some product reviews may highly rate the zoom quality of the camera, while other reviews may provide a relatively lower level of positive sentiment, or even a negative sentiment, associated with the zoom quality. In some implementations, user sentiments associated with attributes of the competitor products are also extracted.

In at least one implementation, the attributes for each product (e.g., product and competitor products) are scored according to associated user sentiment. Then, the attribute scores are used to generate a weighted score of each product. Subsequently, preference mapping is performed to generate a displayable representation, such as a graph, that provides a comparison between the products based on the consumer preference data and relative proximity of each attribute to their corresponding products with respect to associated user sentiment. In implementations, the graph utilizes eigenvector values for the attributes and weighted scores for the products to illustrate which attributes of each product are highly favored by consumers, which indicates the attributes that should be targeted in the marketing campaign to optimize the marketing campaign for the product.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

As employed herein, the term “product” may refer to a good, an idea, information, an object, or a service created as a result of a process and which satisfies a want or need. In implementations, a product may refer to an article or substance that is manufactured or refined for sale. In at least some implementations, a product can have a combination of tangible and intangible attributes such as features, functions, and uses, that a seller offers a buyer for purchase.

As employed herein the term “marketing campaign” may refer to specific activities designed to promote a product or service. A marketing campaign can include efforts to increase awareness (e.g., consumer awareness) of the product or service. In implementations, a marketing campaign can include a coordinated series of steps such as promotion of a product or service through different mediums (e.g., television, radio, print, online, and so on) using a variety of different types of advertisements. The promotion of the product or service can focus on, or highlight, one or more attributes of the product or service to entice consumers (e.g., customers, users, and so on) to purchase the product or service. In at least some implementations, a marketing campaign can have a limited duration. Thus, a “marketing campaign” can refer to a variety of different activities related to promoting a product or service for sale.

As employed herein, the term “attribute” is representative of a quality or feature regarded as a characteristic or inherent part of a product or service. Some examples of attributes can include a feature, an aspect, a function, a use, a characteristic, a property, a trait, an element, and so on. Thus, the term “attribute” can represent any of a variety of attributes. Further examples of the above-described terms may be found in relation to the following discussion.

### Example Environment

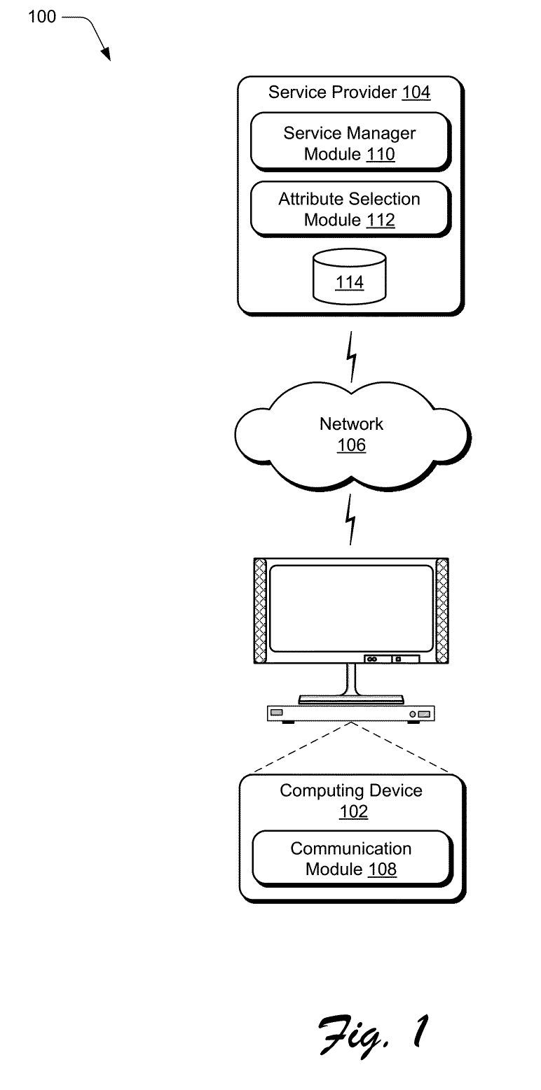

FIG. 1 is an illustration of an environment 100 in an example implementation that is operable to employ techniques described herein. The illustrated environment 100 includes a computing device 102 and a service provider 104 that are communicatively coupled via a network 106. The computing device 102 as well as computing devices that implement the service provider 104 may be configured in a variety of ways.

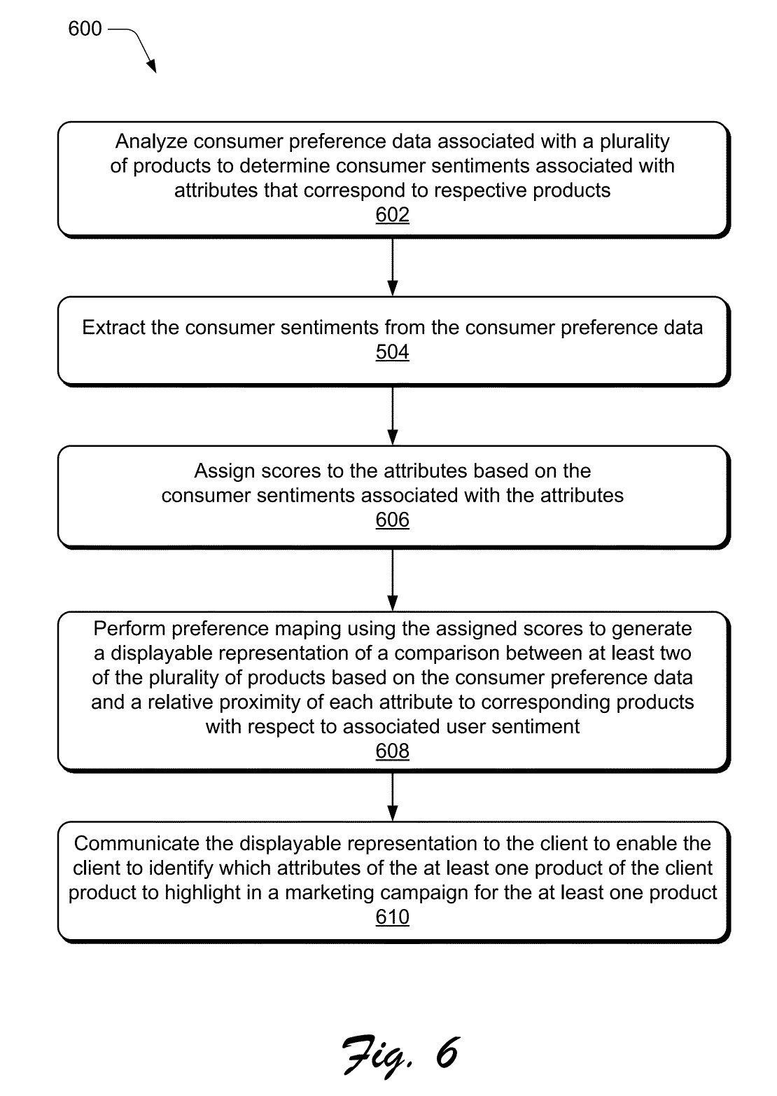

The computing devices, for example, may be configured as a desktop computer, a laptop computer, a mobile device (e.g., assuming a handheld configuration such as a tablet or mobile phone), and so forth. Additionally, a computing device may be representative of a plurality of different devices, such as multiple servers of the service provider 106 utilized by a business to perform operations “over the cloud” as further described in relation to FIG. 6.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be representative of multiple networks.

The computing device 102 is also illustrated as including a communication module 108. The communication module 108 is representative of functionality to communicate via the network 106, such as with one or more services of the service provider 104. As such, the communication module 108 may be configured in a variety of ways. For example, the communication module 108 may be configured as a browser that is configured to “surf the web.” The communication module 108 may also be representative of network access functionality that may be incorporated as part of an application, e.g., to provide network-based functionality as part of the application, an operating system, and so on. Thus, functionality represented by the communication module 108 may be incorporated by the computing device 102 in a variety of different ways.

The service provider 104 is representative of functionality to provide one or more network-based services. The services are managed by a service manager module 110 to support a variety of different functionality. The services (e.g., web services), for instance, may be configured to support review site scraping, consumer preference data review, attribute-selection of a product or service for campaign design, preference mapping, generation of attribute comparison charts, and so on. These services can assist a manufacturer, a distributor, a retailer, an advertiser, or any other entity in identifying which attributes of a product or service to target in a marketing campaign in order to optimize the marketing campaign. Thus, a variety of different types of functionalities may be performed via services supported by the service provider 104.

Service manager module 110 is configured to manage processing of data and/or content requested or provided by the computing device 102. In some instances, a user may wish to communicate with the service provider 104 to request service such as attribute selection for a product or service for use in a marketing campaign. The service manager module 110 can process the user's request and, if needed, communicate the request to an appropriate entity to properly service the request.

The service provider 104 is also illustrated as including an attribute-selection module 112 and storage 114. The attribute-selection module 112 is representative of functionality to provide some of the services of the service provider 104, such as to identify the attributes of a product or service to target in a marketing campaign that can optimize the marketing campaign by targeting the attributes that appeal most to customers. The attribute-selection module 112 is configured to analyze consumer preference data associated with similar products or services, and extract user sentiments corresponding to various attributes of the products or services. In addition, the attribute-selection module 112 is configured to provide an indication of which attributes should be targeted in the marketing campaign based on relative levels of associated positive customer sentiments.

The storage 114 may be a component of the service provider 104, may be remote from the service provider 104, or may be a third-party database. The storage 114 may be a single database, or may be multiple databases, at least some of which include distributed data. Thus, a variety of different types of storage mechanisms can be utilized for the storage 114.

### Example Implementation

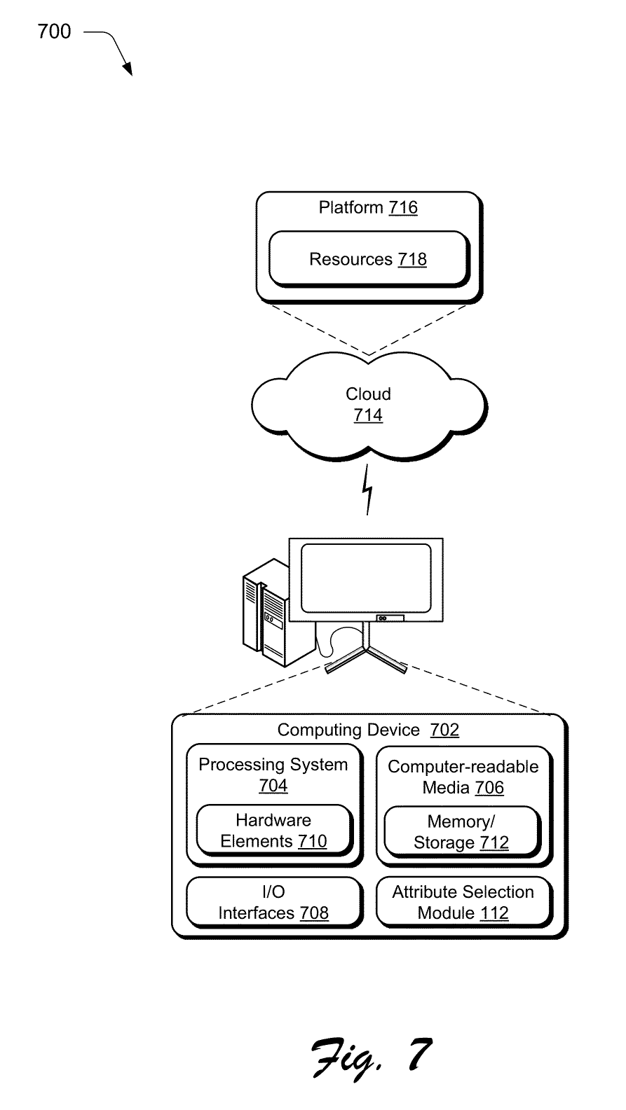

The following discussion describes example implementations of preference mapping for automated attribute selection in campaign design that can be employed to perform various aspects of techniques discussed herein. The example implementations may be employed in the environment 100 of FIG. 1, the system 700 of FIG. 7, and/or any other suitable environment.

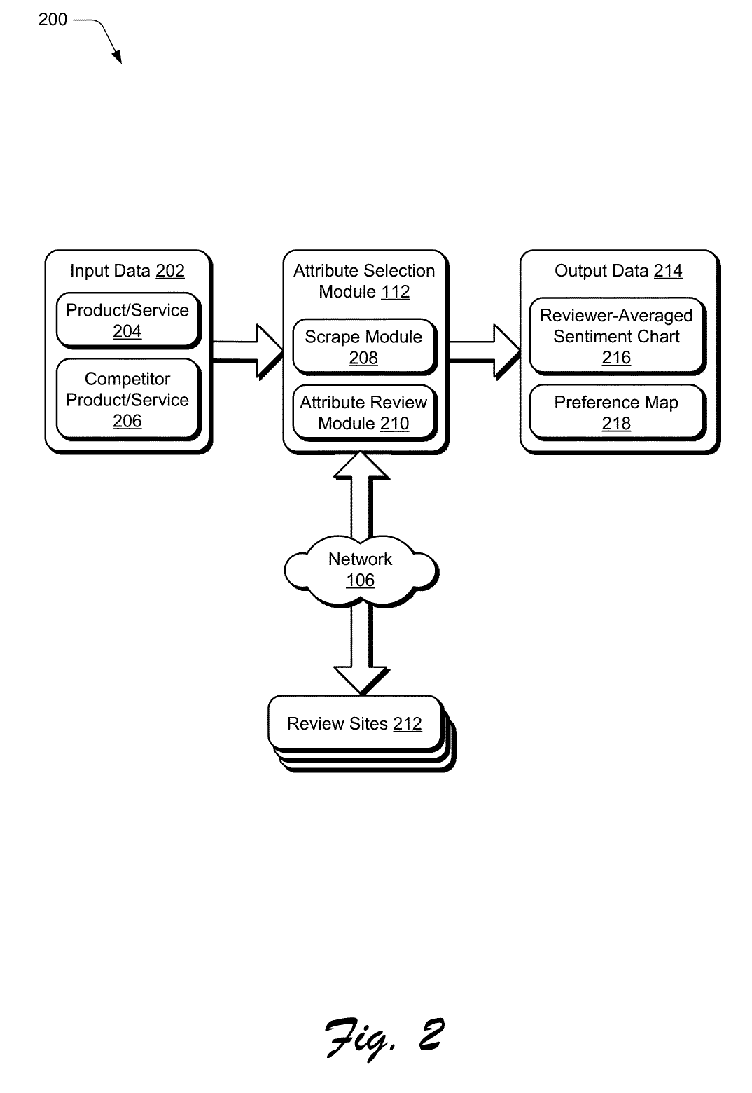

FIG. 2 is an illustration of an example implementation 200 that is operable to employ techniques for preference mapping for automated attribute selection in campaign design. For example, input data 202 is received at the attribute-selection module 112. The input data can include a variety of information including, for example, identification of a product or service 204 that a client is requesting to be analyzed by the attribute-selection module 112. The product or service 204 can include any of a variety of products or services, examples of which are described above. In addition, the input data 202 can include identification of one or more competitor products or services 206 that have similarities to the product or service 204 identified in the input data 202. For example, the competitor products or services 206 can have one or more attributes (e.g., features, functionalities, aspects, characteristics, and so on) that are substantially similar to one or more attributes of the product or service 204 of the client.

The attribute-selection module 112 is illustrated as including a scrape module 208 and an attribute review module 210. In implementations, the scrape module 208 is configured to scrape review data from review sites 212. The review sites 212 can include websites (e.g., merchant sites, forums, survey sites, and so on) that receive or otherwise accept consumer feedback by users (e.g., reviewers) that purchased and/or used the product or service 204 of the client or the competitor products or services 206. In implementations, the consumer feedback includes electronic feedback such as textual reviews, customer surveys, and so on. In at least one approach, the review data can provide an indication of which attributes were liked or disliked by the users based on text or other indicators used by the users in the feedback. In an example, the consumer feedback can include a rating system for the users to rate various attributes of the product or service based on the user's sentiment associated with each respective attribute. In implementations, the scrape module 208 is configured to collect the review data that corresponds to the product or service 204 of the client, and the review data that corresponds to the competitor products or services 206 identified in the input data 202.

The attribute review module 210 is configured to analyze the collected review data. In implementations, the attribute review module 210 is configured to search the review data to locate consumer reviews that mention or otherwise describe one or more attributes of the product or service 204 or of the competitor products or services 206. Further, the attribute review module 210 is configured to extract positive, neutral, and/or negative user sentiments associated with each attribute and assign a score to each attribute in each review based on a level of associated sentiment. In implementations, positive, neutral, and negative sentiments are assigned positive, zero, and negative scores, respectively. Accordingly, a relatively high magnitude of score corresponds to a relatively high strength of an emotion associated with the attribute.

Following this, scores are averaged over the reviewers for each attribute for each product. Using the averaged scores of each of the various attributes for the different products, the attribute review module 210 can perform preference mapping. The scores are scaled to the same range to cause associated variances to be comparable across attributes of each product. For example, consider X=(X₁, X₂, . . . , Xₚ)^{T} as a matrix representing reviewer-averaged scores for p products (e.g., different camera models) and n attributes (e.g., battery life, size of display, shutter delay, and so on). Each Xᵢ refers to a vector with its elements Xᵢⱼ, which is the reviewer-averaged sentiment score for attribute j of product i. For example, in a comparison of different camera models, X₁ can refer to a vector for an attribute of a first camera, and X₂ can refer to a vector for the same attribute but from a second camera.

A principal component (PC) transformation of X can be calculated using the following equation:

Y=Γ^{T}(X−μ) Equation 1

In Equation 1, the term Y refers to a transformation of X, such that the variance of Y is maximized. Further in equation 1, the term μ=E(X), where E(X) refers to the expectation of X. In addition, the following equation can be used to calculate the variance (e.g., “Var”) of X:

Σ=Var(X)=ΓΔΓ^{T} Equation 2

In equation 2, the term Γ refers to a vector of eigenvectors γ₁, γ₂, . . . , γₚ, that correspond to eigenvalues λⱼ of the matrix X, described below. Further in equation 2, the term Δ refers to a diagonal matrix of X. The transformation of X is such that the variance of Y (e.g., “Var(Y)”) is maximized and the following holds:

λ₁≧λ₂≧ . . . ≧λₚ Equation 3

where the term Var(Yⱼ)=λⱼ, and j=1, 2, . . . , p. In addition, the transformation of X is such that the following also holds:

E(Yⱼ)=0 Equation 4

and

Cov(Yⱼ,Yᵢ)=0 when i≠j Equation 5

In equation 4, the term E(Yⱼ) refers to the expectation of Y for the attribute j, and in equation 5, the term Cov(Yⱼ, Yᵢ) refers to the covariance of Y for the attribute j of product i. The eigenvalues λⱼ have corresponding eigenvectors as γ₁, γ₂, . . . , γₚ (e.g., the number of eigenvectors is equal to a rank of the matrix X). In implementations, a weighted sum of the scores of each product across the attributes is then represented by the i^{th} PC for the respective product. The weights can be obtained from the i^{th} eigenvector.

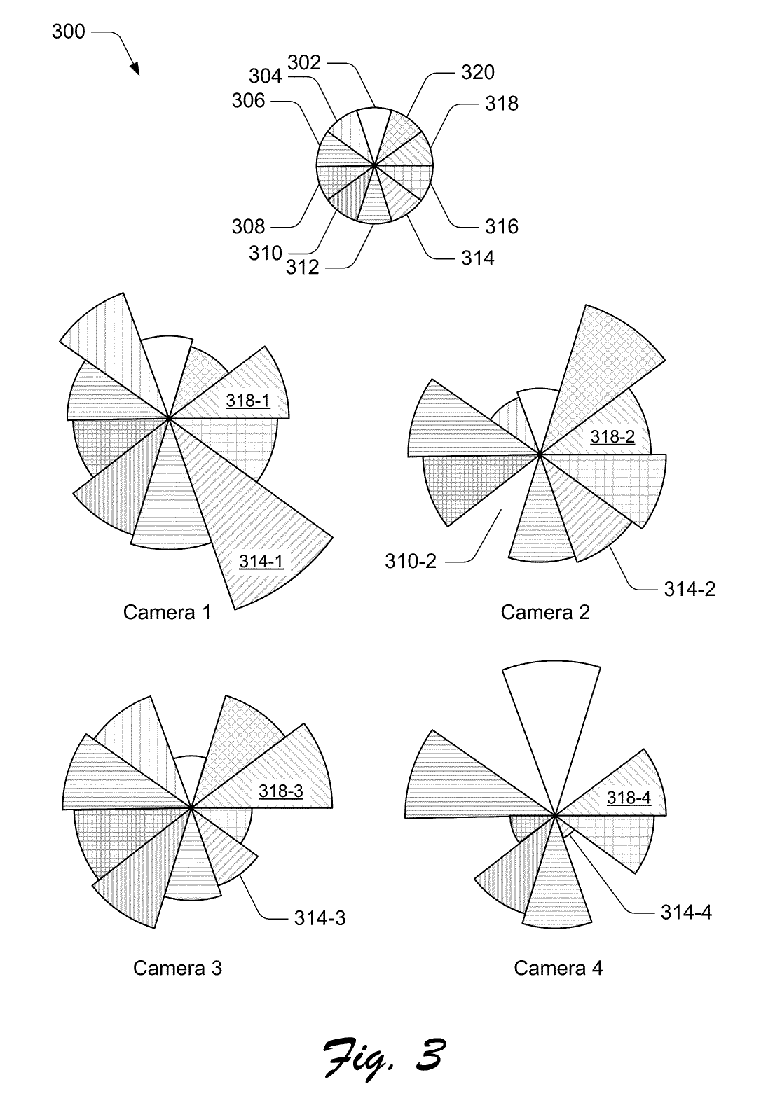

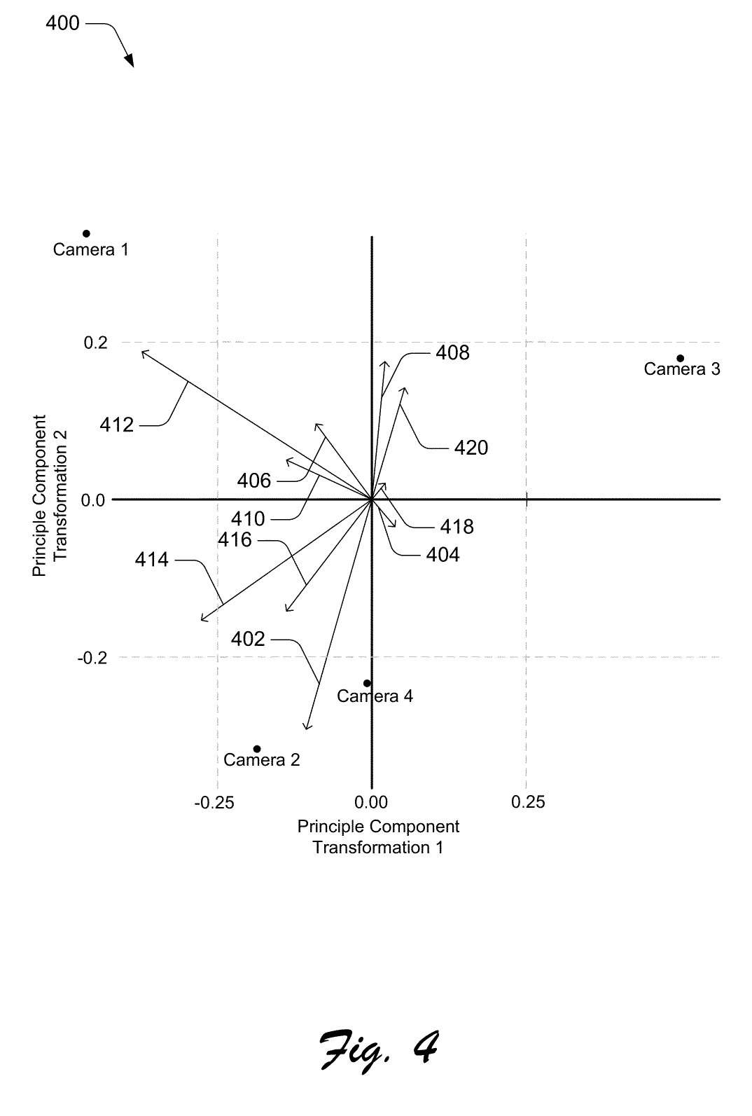

Using at least the above equations, output data 214 can be generated, such as a reviewer-averaged sentiment chart 216, and/or a preference map 218, examples of which are described below with respect to FIGS. 3 and 4, respectively. In implementations, a displayable representation (e.g., preference map) can be generated for a first PC and a second PC with the weighted scores of each of the products and the eigenvector values for each attribute. The resultant graph (e.g., biplot graph) is configured to present an easily interpretable visualization that illustrates a comparison of products based on consumer reviews and relative proximity of each attribute to corresponding products with respect to associated user sentiment.

Based on the resultant multivariate visualization, a marketing campaign can be designed highlighting favorable attributes of a product. In an example, the marketing campaign can target consumer-favored attributes of a new product model that has a relatively small number of consumer reviews. Further, using the techniques described herein, the displayable representation may not suffer from the “cold start problem” since the input data used is acquired from review data associated with other products or services in addition to review data associated with the product.

FIG. 3 is an illustration of an example implementation 300 in which average sentiment scores of various attributes for different models of a product are charted. The illustrated implementation 300 includes various models of a product (e.g., cameras 1-4), each associated with a radial chart having portions representing user sentiment associated with respective attributes. For example, once review data is collected and analyzed to extract user sentiment associated with various attributes of one or more products, the attributes for each product are scored according to a level of associated sentiment. Following this, scores for each attribute for the product are averaged over all reviewers that mentioned the attribute in their feedback. In implementations, neutral sentiments are scored zero, thereby contributing zero to the averaged score. In addition, missing observations in the review data are assumed to be neutral sentiments, and corresponding scores are assumed to be zero.

The average score for each attribute is then associated with a portion of the radial chart corresponding to that attribute. For example, each portion of the radial chart can be associated with an attribute, such as delay 302, flash 304, function 306, lens 308, resolution 310, start speed 312, view 314, zoom 316, battery life 318, and color 320. In an example, assume camera 3 was mentioned in 13 reviews, with seven, one, and five reviews showing positive, negative, and neutral scores, respectively. While the numbers of positive and negative reviews may seem comparable, the averaged positive and negative sentiment scores result in 1.3461 and 0.3569 respectively, indicating that the strength of the negative sentiment was not as strong as the positive sentiment. Finally, the two values can be averaged to obtain an average score of 0.8515.

In implementations, some of the attributes can have similar scores. For example, the battery life 318-1 of camera 1 is shown to have substantially similar associated positive sentiment as the battery life 318-2 of camera 2, the battery life 318-3 of camera 3, and also the battery life 318-4 of camera 4. Other attributes, however, can have substantially different sentiment scores, reflecting differing user sentiments for a same attribute of different product models. For example, the view 314-1 of camera 1 is illustrated as having a relatively high positive sentiment score while the view 314-4 of camera 4 is illustrated as having a relatively low positive sentiment score. In addition, the view 314-2 of camera 2 and the view 314-3 of camera 3 are illustrated as having moderate sentiment scores in comparison with the view 314-1 of camera 1 and the view 314-4 of camera 4. In at least some implementations, negative sentiment scores may outweigh positive sentiment scores, resulting in a negative averaged score, which can be assumed to be zero for purposes of the preference mapping. For example, the resolution 310-2 of camera 2 is illustrated as having an approximately negligent score, indicating that consumers did not like the resolution 310-2 of camera 2.

FIG. 4 illustrates an example preference map 400 showing weighted scores of products (e.g., cameras 1-4 from FIG. 3) and corresponding eigenvector-associated attributes. The averaged sentiment score for an attribute of a camera can be referred to as a camera-attribute pair. Consequently, a matrix is generated having rows corresponding to each camera, and columns corresponding to each attribute, and cells including the averaged sentiment score associated with each camera-attribute pair. A principal component analysis (PCA) can then be performed on the matrix of camera-attribute pairs, and the results can be plotted in a biplot. In the example preference map 400 illustrated in FIG. 4, the weighted scores of the cameras and the eigenvectors of each of the attributes are plotted over a first principal component transformation (PC1) and a second principal component transformation (PC2) to illustrate a comparison between each of the attributes and associated cameras.

In the illustrated example, the various arrows represent the eigenvectors of each attribute and the black dots represent the weighted score of each product. In implementations, the attributes (e.g., arrows) pointing towards a same or similar direction, represent attributes that tend to be highly positively correlated. Additionally, an attribute pointing toward a product indicates that the product has a high value for that attribute. Accordingly, attributes that are closer in proximity, and which point toward, a particular product, are attributes that should be highlighted in the marketing campaign for that product.

In the illustrated example, the arrows correspond to the attributes shown in FIG. 3, and include delay 402, flash 404, function 406, lens 408, resolution 410, start speed 412, view 414, zoom 416, battery life 418, and color 420. In addition, the cameras 1-4 are plotted in a location representing a respective association with each attribute. The example preference map 400 indicates that camera 1 and camera 3 received relatively high sentiment scores associated with attributes such as lens 408 and color 420, whereas camera 2 and camera 4 received relatively high sentiment scores associated with attributes such as delay 402 and zoom 416. Thus, as indicated by the example preference map 400, the marketing campaign for camera 1 should target attributes such as lens and color rather than zoom, while the marketing campaign for camera 2 should target attributes such as delay and zoom rather than lens and color.

### Example Procedures

The following discussion describes techniques for preference mapping for automated attribute selection in campaign design that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1.

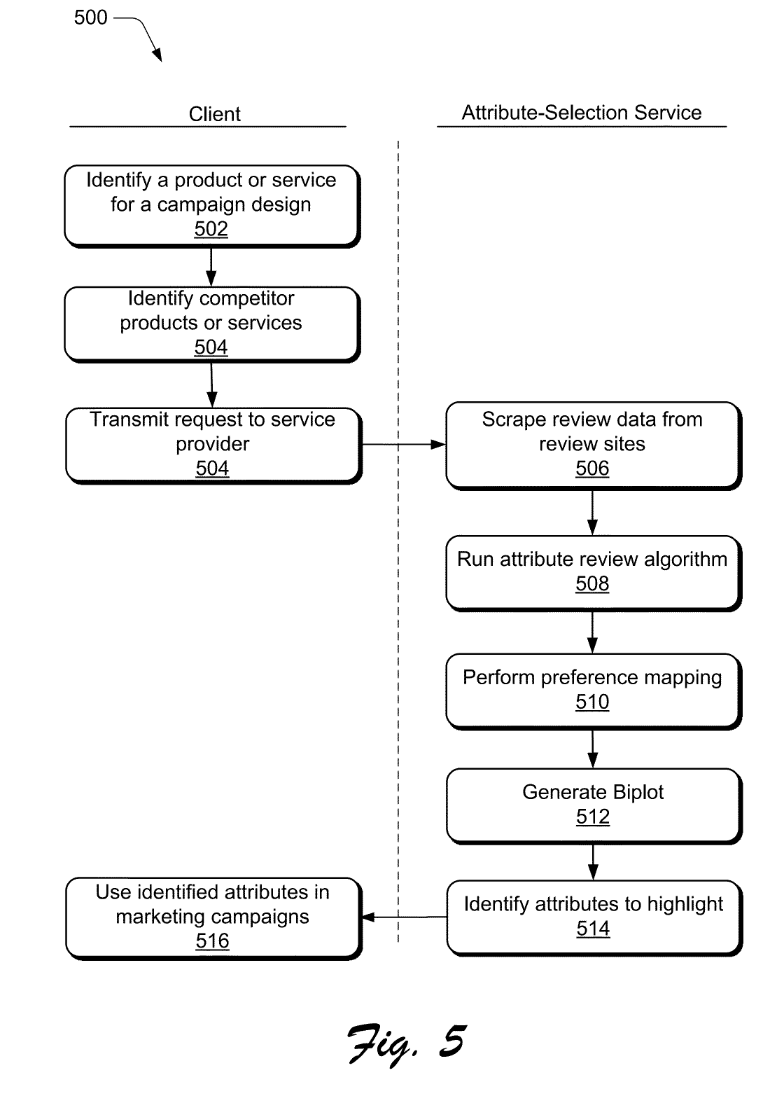

FIG. 5 is a flow diagram depicting a procedure in an example implementation in which techniques for preference mapping for automated attribute selection in campaign design are employed. A product or service is identified for campaign design (block 502). This step can be performed in any suitable way. For example, a new model of a product or a newly implemented service can be identified as a subject for a marketing campaign to target specific attributes that will encourage potential customers to purchase the product or service.

Competitor products or services are identified (block 504). For example, one or more products or services of a competitor that have similar attributes as the product or service identified for the marketing campaign can be identified.

A request to a service provider is transmitted (block 504). In at least some implementations, the request includes identification of the product or service as well as identification of the competitor products or services. The request can include a request to identify one or more attributes of the product or service to target in a marketing campaign for the product or service based on consumer preference data.

Once the request is received at the service provider, the service provider can implement or otherwise initiate an attribute-selection service to scrape review data from review sites (block 506). This step can be performed in any suitable way. For example, the attribute-selection service can utilize a scrape module or other component configured to scrape review data having consumer feedback associated with one or more attributes of the product or service as well as consumer feedback associated with the competitor products or services. The review data can include, for example, consumer feedback, product reviews, consumer surveys, and so on, with respect to various features of the product or service, as well as various features of the competitor products or services.

An attribute review algorithm is run (block 508). For example, the review data can be analyzed using an attribute review algorithm to extract user sentiments associated with the various attributes of the product or service and of the competitor products or services. In implementations, each attribute for each product is scored over all the reviewers that described the attribute in their consumer feedback. Further, the scores for each attribute are averaged to generate a reviewer-averaged score for each attribute of each product or service.

Preference mapping is performed (block 510). This step can be performed in any suitable way, examples of which are described above. For example, preference mapping can include scaling the reviewer-averaged scores to a same scale to enable associated variances to be comparable across different attributes of each product or service. In implementations, a principal component transformation algorithm can be utilized to calculate the variances of the attributes for each product or service, and a weighted sum of each product or service across the attributes.

A biplot is generated (block 512). This step can be performed in any suitable way, examples of which are described above. In implementations, the biplot can be generated by using the weighted sum of each product or service and the variances of the attributes for each product or service. The biplot is generated to provide a visual indication of how each of the products or services (including the competitor products or services) identified in the request compare to one another based on consumer preference data and based on relative proximity of attributes to corresponding products or services with respect to associated user sentiments identified in the consumer preference data.

Attributes to highlight are identified (block 514). For example, attributes that correspond to vectors pointing toward the product or service are identified as having highly positive associated user sentiment. These are the attributes that can be recommended to target in a marketing campaign for the product or service. Because these attributes have high positive user sentiment, potential customers may be likely to purchase the product or service based on the identified attributes.

An indication of the identified attributes can be transmitted to the requesting entity (e.g., client) to respond to the request. Subsequently, the identified attributes can be used in marketing campaigns (block 516). In implementations, the requesting entity can use the indication to identify which attributes to target in the marketing campaign for the product or service. Accordingly, the requesting entity can optimize the marketing campaign for the product or service by targeting the attributes that appeal most to potential customers.

Having discussed a general procedure with respect to FIG. 5, consider now a discussion of FIG. 6, which is a flow diagram depicting a procedure 600 in an example implementation in which techniques for reference mapping for automated attribute selection in campaign design are employed. Consumer preference data associated with a plurality of products is analyzed by one or more computing devices to determine user sentiments associated with attributes that correspond to respective products (block 602). In one or more implementations, the plurality of products include a product of a client and at least one competitor's product.

User sentiments are extracted from the consumer preference data (block 604). This step can be performed in any suitable way, examples of which are described above. Scores are assigned by the one or more computing devices to the attributes based on the user sentiments associated with the attributes (block 606). For example, scores can include positive, neutral, and negative scores assigned to respective attributes based on a level of positive, neutral, and negative user sentiment, respectively. In implementations, the scores can be averaged for each attribute of each product. Additionally, the scores can be scaled to a same range to enable comparison of different attributes of each product.

Preference mapping is performed by the one or more computing devices using the assigned scores to generate a displayable representation of a comparison between at least two of the plurality of products based on the consumer preference data and a relative proximity of each attribute to corresponding products with respect to associated user sentiment (block 608). This step can be performed in any suitable way, examples of which are described above. In at least some implementations, the relative proximity of the attributes to corresponding products is based on eigenvector values associated with each attribute. In one approach, the preference mapping includes a principal component analysis. In implementations, the displayable representation includes a biplot of weighted scores for each product and eigenvectors for each attribute of the products.

The displayable representation is communicated by the one or more computing devices such that the displayable representation is identifiable regarding which attributes of the at least one product of the client product to highlight in a marketing campaign for the at least one product (block 610). This step can be performed in any suitable way, examples of which are described above. In at least one implementation, the displayable representation can be used to identify which attributes of a product correspond to relatively high positive user sentiment. Thus, the identified attributes can be used to optimize a marketing campaign for the product.

### Example System and Device

FIG. 7 illustrates an example system generally at 700 that includes an example computing device 702 that is representative of one or more computing systems and/or devices that may implement the various techniques described herein. This is illustrated through inclusion of attribute-selection module 112, which may be configured to identify which attributes of a product or service to target in a marketing campaign based on consumer preference data. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

Cloud 714 includes and/or is representative of a platform 716 for resources 718. Platform 716 abstracts underlying functionality of hardware (e.g., servers) and software resources of the cloud 714. Resources 718 may include applications and/or data that can be utilized while computer processing is executed on servers that are remote from the computing device 702. Resources 718 can also include services 720 provided over the Internet and/or through a subscriber network, such as a cellular or Wi-Fi network.

Platform 716 may abstract resources and functions to connect computing device 702 with other computing devices. Platform 716 may also serve to abstract scaling of resources to provide a corresponding level of scale to encountered demand for resources 718 that are implemented via platform 716. Accordingly, in an interconnected device embodiment, implementation of functionality described herein may be distributed throughout system 700. For example, the functionality may be implemented in part on computing device 702 as well as via platform 716 that abstracts the functionality of cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method, comprising:
analyzing consumer preference data associated with a plurality of products by one or more computing devices to determine user sentiments associated with attributes that correspond to respective products, the plurality of products including at least one product of a client and at least one competitor's product;
assigning scores by the one or more computing devices to the attributes based on the user sentiments associated with the attributes;
performing preference mapping by the one or more computing devices using the assigned scores to generate a displayable representation of a comparison between at least two of the plurality of products based on the consumer preference data and a relative proximity of each attribute to corresponding products with respect to associated user sentiment; and
communicating the displayable representation by the one or more computing devices such that the displayable representation is identifiable regarding which attributes of the at least one product of the client to highlight in a marketing campaign for the at least one product.

2. A computer-implemented method as recited in claim 1, further comprising extracting the user sentiments from the consumer preference data.

3. A computer-implemented method as recited in claim 2, wherein the consumer preference data is based on one or more of consumer feedback, textual reviews, or consumer surveys of product attributes.

4. A computer-implemented method as recited in claim 1, wherein the sentiments include one or more positive, neutral, and negative sentiments associated with the attributes.

5. A computer-implemented method as recited in claim 1, further comprising averaging the scores for each attribute for each product

6. A computer-implemented method as recited in claim 1, wherein the scores are scaled to a same range to enable comparison of different attributes of each product.

7. A computing device comprising:
one or more processors; and
a memory having instructions that are executable by the one or more processors to implement an attribute-selection module that is configured to:
transmit a request to a service provider to identify one or more attributes of a client product to target in a marketing campaign for the client product based on consumer preference data, the request identifying the client product and one or more competitor products that are similar to the client product;
receive a displayable representation of a comparison of the client product to the one or more competitor products based on the consumer preference data and a relative proximity of attributes to corresponding products with respect to associated user sentiment identified in the consumer preference data; and
use the displayable representation to identify the one or more attributes of the client product to target in the marketing campaign for the client product.

8. A computing device as recited in claim 7, wherein the consumer preference data includes user sentiments associated with the one or more attributes.

9. A computing device as recited in claim 8, wherein the consumer preference data is extracted from textual reviews for the client product and additional textual reviews for the one or more competitor products.

10. A computing device as recited in claim 7, wherein the relative proximity of attributes to corresponding products is based on scores assigned to each attribute that correspond to a level of user sentiment associated with the attribute.

11. A computing device as recited in claim 7, wherein the user sentiments include one or more positive, neutral, or negative sentiments associated with the attributes.

12. A computing device as recited in claim 7, wherein the relative proximity of attributes to corresponding products is based on eigenvector values associated with each attribute

13. A system comprising:
one or more modules implemented at least partially in hardware, the one or more modules configured to perform operations comprising:
receiving a request to identify one or more attributes of a client product to target in a marketing campaign based on user sentiments associated with each attribute, the request identifying the client product and one or more competitor products;
based on the request, collecting electronic consumer feedback associated with the client product and the one or more competitor products;
extracting user sentiments associated with various attributes of the client product and the one or more competitor products;
performing preference mapping of the various attributes of the client product and the one or more competitor products to compare the various attributes based on associated positive user sentiments from the user sentiments;
identifying the one or more attributes of the client product from the various attributes to target in the marketing campaign based on the preference mapping of the various attributes.

14. A system as recited in claim 13, wherein the operations further comprise communicating a response to the request that indicates the one or more attributes of the client product to target in the marketing campaign.

15. A system as recited in claim 13, wherein the operations further comprise communicating a displayable plot that visually depicts a relationship between each attribute and corresponding products with respect to the positive user sentiments.

16. A system as recited in claim 13, wherein the consumer feedback includes one or more of consumer surveys or textual reviews.

17. A system as recited in claim 13, wherein the operations further comprise assigning scores to each attribute based on user sentiments associated with each attribute.

18. A system as recited in claim 17, wherein the scores are scaled to a same range to enable comparison across attributes of each product.

19. A system as recited in claim 13, wherein the preference mapping includes a relative proximity of attributes to corresponding products based on eigenvector values associated with each attribute.

20. A system as recited in claim 13, wherein the operations further comprise generating a biplot using principle component transformation that illustrates weighted scores for each product and eigenvector values for each attribute.
